(19) United States
(12) Patent Application Publication
(10) Pub. No.: US 2010/0207538 A1
(43) Pub. Date: Aug. 19, 2010

(54) ELECTRONIC CANDLE STRUCTURE

(75) Inventor: Kuo-Fang Chen, Sindian City (TW)

Correspondence Address: Muncy, Geissler, Olds & Lowe, PLLC, 4000 Legato Road, Suite 310, FAIRFAX, VA, 22033, US

(73) Assignee: Nature Candle Corporation

(21) Appl. No.: 12/371,259

(22) Filed: Feb. 13, 2009

(51) Int. Cl. H05B 41/36; F21V 35/00; F21L 4/00

(52) U.S. Cl. 315/291; 362/392; 362/157

(57) ABSTRACT

The present invention relates to an improved structure for an electronic candle, and is primarily fabricated from a candle column, which is solidified and formed from molten wax, and a supporting device primarily structured from a supporting body and a base. An electronic device located within the base enables a light-emitting element and a heater base on the supporting body to obtain electricity, and different smelling essential oils can be added within the heater base according to user preference, thereby enabling electricity supplied by the electronic device to heat and cause the essential oils to volatize and release a fragrant aroma. Accordingly, the user can choose different ambient lights to fashion exquisite streams of light according to his mood, and the heater base can be used to volatilize the added essential oils as the temperature rises to achieve the objective of filling a room with an aromatic odor.

### BACKGROUND OF THE INVENTION

(a) Field of the Invention

The present invention provides an electronic aromatic candle, and more particularly provides an improved structure for an electronic candle which enables selecting different lights according to different requirements to fashion a candle producing different ambiences and fragrant aromas.

(b) Description of the Prior Art

The rapid progress of modern times has put ever increasing pressure on the lives of modern people, thus, many people seek methods to relieve pressure or use some small personal ornaments to achieve a pressure relieving effect. Taking candles as an example, many people purchase different styled candles to serve as pressure relieving ornaments. Because traditional candles are structured from a main candle body and a cotton candlewick, thus, when the cotton candlewick is lit, then the main candle body simultaneously begins to melt to enable maintaining burning of the candle until the main candle body has completely burned away. However, prior art candles are only able to provide an indoor monotonous candlelight; even methods whereby companies solidified different styled candles using different molds do not have the visual effect to change the mood of people.

Furthermore, because burning of such candles requires oxygen to support combustion, thus, if there are people inside the room where a candle is burning, then there is the possibility of oxygen deficiency occurring. Moreover, candlelight can only be produced using the flame from the candle, however, should the candle set fire to surrounding combustibles when not paying attention, then it will endanger the safety of oneself and other people and property. In addition, an unpleasant odor and smoke are produced when candles are burning, which not only results in poor indoor air quality poor, moreover, it is unable to achieve putting the user in a good mood.

Hence, it is the strong desire of the inventor and manufacturers engaged in related art and purpose of the present invention to resolve and surmount existent technical difficulties to resolve the problems and shortcomings of the aforementioned prior art.

### SUMMARY OF THE INVENTION

Hence, in light of the shortcomings of the aforementioned prior art, the inventor of the present invention, having collected related data, and through evaluation and consideration from many aspects, as well as having accumulated years of experience in related arts, through continuous testing and improvements has designed a new improved structure for an electronic candle as disclosed in the present invention which enables selecting different lights according to different requirements to fashion a candle producing different ambiences and fragrant aromas.

The primary objective of the present invention lies in: An electronic candle fabricated from a candle column and a supporting device, wherein the candle column is solidified and formed from molten wax, and the supporting device is primarily structured from a supporting body and a base. An electronic device located within the base enables a light-emitting element and a heater base on the supporting body to obtain electricity, thereby enabling the light-emitting element to emit light. Moreover, different smelling essential oils can be added within the heater base according to user preference, and electric energy supplied by the electronic device is used to heat and cause the essential oils to volatize and release a fragrant aroma. Furthermore, the user can choose different ambient lights to fashion exquisite streams of light according to his mood.

Another objective of the present invention lies in: The aforementioned structure is used to enable the heater base, a resistance and the electronic device to volatilize the added essential oils as the temperature rises to achieve the objective of filling a room with an aromatic odor.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is an elevational schematic view of an electronic candle of the present invention.

FIG. 2 is an elevational exploded schematic view of the electronic candle of the present invention.

FIG. 3 is a schematic view of an operating state using a candle flame as the primary context according to the present invention.

FIG. 4 is a schematic view of an operating state of another preferred embodiment using variation in different lights as the primary context according to the present invention.

### DETAILED DESCRIPTION OF THE PREFERRED EMBODIMENTS

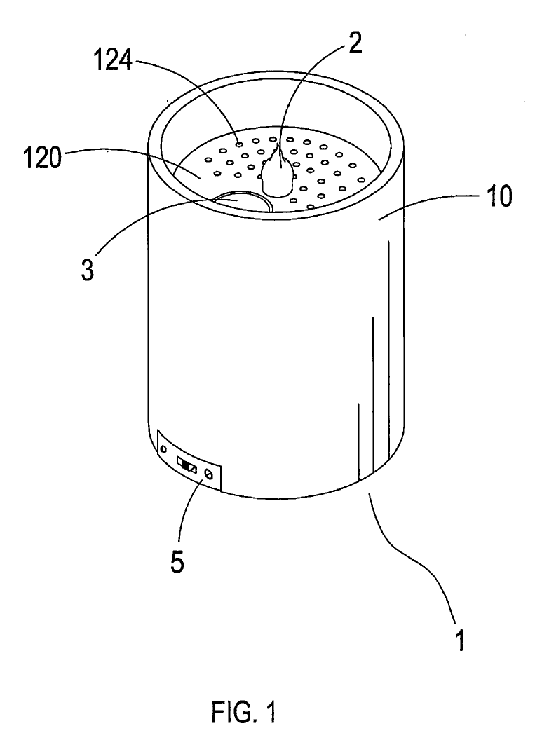

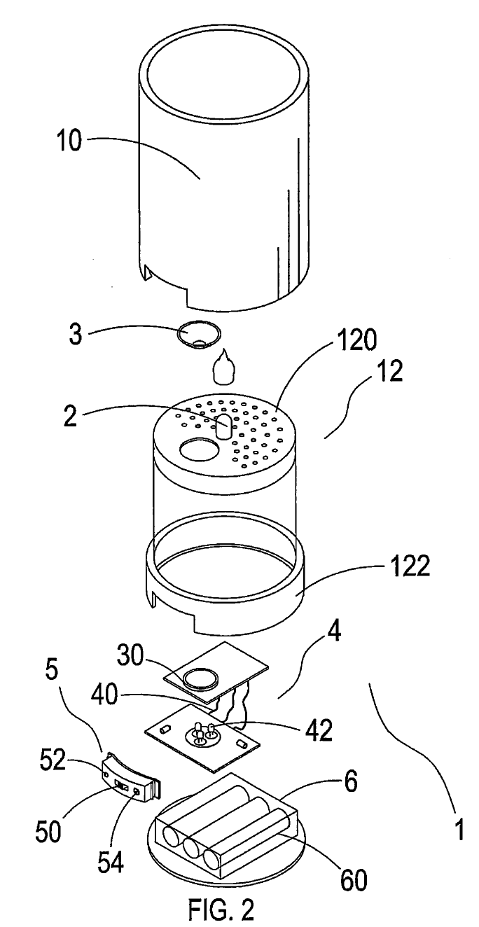

Referring to FIG. 1 and FIG. 2, which show an elevational schematic view and an elevational exploded schematic view respectively of an electronic candle of the present invention, and it can be clearly seen from the drawings that the present invention provides an improved structure for an electronic candle, wherein an electronic candle 1 is primarily fabricated from a candle column 10 and a supporting device 12. The candle column 10 is solidified and formed from molten wax, and the supporting device 12 is primarily structured from a supporting body 120 and a base 122. Moreover, a light-emitting element 2 and a heater base 3 are mounted on the supporting body 120, and a resistance 30 is located underneath the heater base 3. The resistance 30 and circuit wires 40 of an electronic device 4 form an electrical circuit, which is used to enable the resistance 30 to convert the received electric energy into heat energy that can then be conducted to the heater base 3, thereby causing essential oils positioned on the heater base 3 to be heated and volatilized to produce a fragrant aroma. In addition, the supporting body 120 is formed with a plurality of convection holes 124 which enable communication with the internal air of the supporting device 12. Hence, the convection holes 124 are used to transfer the internal heat energy and thereby alleviate the internal high temperature condition.

The aforementioned electronic device 4 is installed within the base 122, and the base 122 is fitted with light-emitting bodies 42 on the electronic device 4. In addition, the electronic device 4 is connected to a control device 5, and the control device 5 is fabricated from a power control device 50, a power indicator light 52 and a power supply jack 54, wherein the power control device 50 is able to control whether the light-emitting element 2, the light-emitting bodies 42 and the heater base 3 are actuated or not according to user requirements. Because the power control device 50 forms an electrical connection with the power indicator light 52, thus, the power indicator light 52 is able to display user mode at all times, thereby avoiding a situation of insufficient electrical voltage from occurring. Furthermore, electrical connection of the power indicator light 52 with the power supply jack 54 enables the user to know whether the user mode is normal or not when using a transformer battery charger.

Furthermore, a power device 6 is installed in a bottom portion of the base 122 to enable lithium batteries 60 to be disposed therein to supply electric energy to the power control device 50 and the power indicator light 52, thereby doing away with the need to use a transformer battery charger, and achieving the objective whereby use of the electronic candle 1 is not limited by environmental constraints.

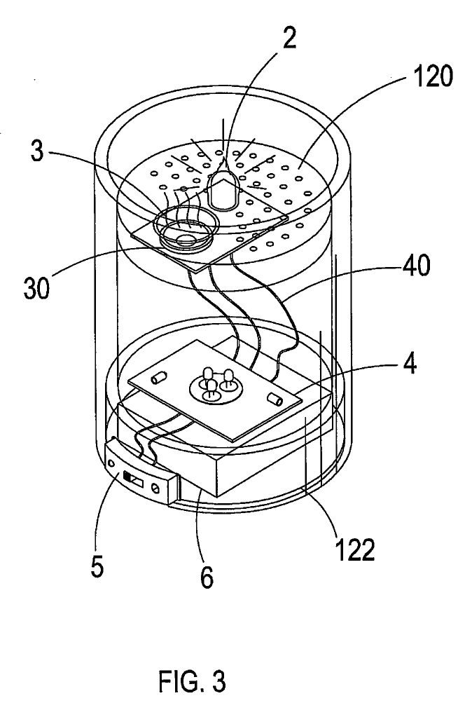

Referring to FIG. 3, which shows a schematic view of an operating state using a candle flame as the primary context according to the present invention, and it can be clearly seen from the drawing that, taking the light-emitting element 2 as an example of a candle flame, when the user wants to activate the light-emitting element 2 positioned on the supporting body 120, then the user needs only move a switch disposed on the control device 5 to the left, at which time the electronic device 4 positioned on the base 122 realizes an electrical connection with the power device 6 and electric energy is transmitted to the light-emitting element 2 through the circuit wires 40, whereupon the resistance 30 on the supporting body 120 receives the electric energy transmitted by the circuit wires 40, and the resistance 30 converts the electric energy into heat energy. The heat energy is then conducted to the heater base 3, at which time the essential oils positioned within the heater base 3 gradually volatilize as the temperature rises, and a fragrant aroma of the essential oils is released during the volatility process. Accordingly, the user can change the ambience within a room using the light-emitting element 2 on the supporting body 120, while at the same time filling the room with an aromatic odor from the fragrance released by the essential oils, thereby putting the user in a pleasant mood. In addition, different smelling essential oils can be added within the heater base 3 according to user preference and heated using the electric energy supplied by the electronic device 4 to cause the essential oils to volatize and release the aromatic odor.

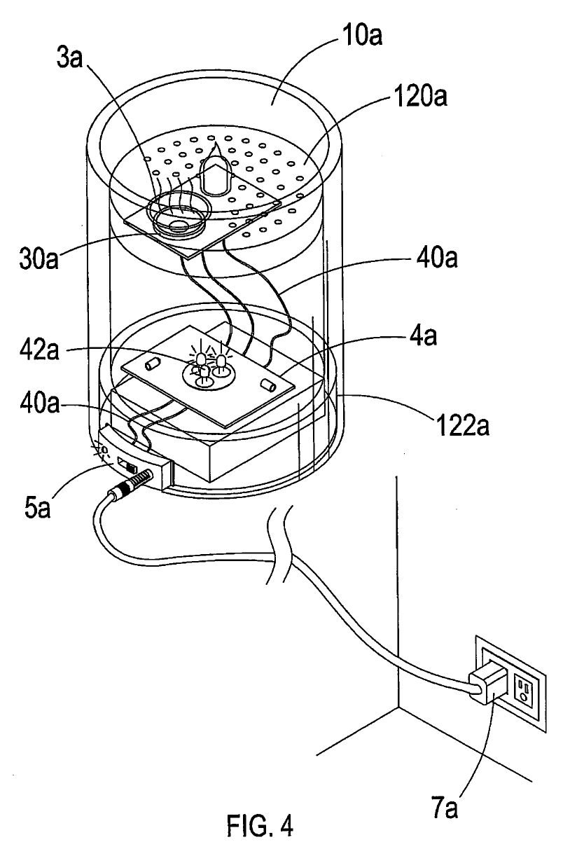

Referring to FIG. 4, which shows a schematic view of an operating state of another preferred embodiment using variation in different lights as the primary context according to the present invention, and it can be clearly seen from the drawing that, taking light-emitting bodies 42a as an example of different lights, when the user wants to activate the light-emitting bodies 42a located on a base 122a, then the user needs only to move the switch disposed on a control device 5a toward the right, at which time an electronic device 4a located on the base 122a realizes an electrical connection with a transformer battery charger 7a and causes electric energy to be transmitted to the light-emitting bodies 42a through circuit wires 40a, whereupon a resistance 30a located on a supporting body 120a receives the electric energy transmitted by the circuit wires 40a. The resistance 30a then converts the electric energy into heat energy, and the heat energy is conducted to a heater base 3a, at which time the essential oils positioned within the heater base 3a gradually volatilize as the temperature rises, and a fragrant aroma of the essential oils is released during the volatility process. Accordingly, the user can change the ambience within a room using the light-emitting bodies 42a on the base 122a, while at the same time filling the room with an aromatic odor from the fragrance released by the essential oils, thereby putting the user in a pleasant mood. In addition, different smelling essential oils can be added within the heater base 3a according to user preference and heated using the electric energy supplied by the electronic device 4a to cause the essential oils to volatize and Release the aromatic odor. Furthermore, because an aromatic essence candle column 10a and a supporting device 12a assume a transparent state and a semitransparent state, thus, exquisite streams of light can be fashioned by selecting different ambient lights.

In conclusion, the improved structure for an electronic candle of the present invention is clearly able to achieve the effectiveness and objectives as disclosed when in use, and is indeed a practical and exceptional invention that complies with the essential elements as required for a new patent application. Accordingly, a new patent application is proposed herein.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An electronic candle structure, comprising:
a candle column, the candle column is solidified and formed from molten wax, and the candle column is formed with a hollow section; and
a supporting device, the supporting device is located within the hollow section and comprises:
a supporting body, the supporting body is provided with a supporting surface, and the supporting surface is mounted with a light-emitting element and a heater base; and
a base, the base is fitted with an electronic device, and the electronic device uses circuit wires to form an electrical circuit the light-emitting element and the heater base.

2. The electronic candle structure according to claim 1, wherein the supporting body is formed with a plurality of convection holes which enable communication with the internal air of the supporting device.

3. The electronic candle structure according to claim 1, wherein a resistance is located at a bottom portion of the heater base, and the electronic device forms an electrical connection with the resistance using the circuit wires, thereby heating the heater base filled with essential oils and causing the essential oils to volatize and produce a fragrant aroma.

4. The electronic candle structure according to claim 1, wherein the base is mounted with light-emitting bodies which are electrically connected to the electronic device.

5. The electronic candle structure according to claim 1, wherein a control device is connected to the electronic device, and the control device comprises:
a power control device, the power control device controls the starting state of the light-emitting element, the light-emitting bodies and the heater base;
a power indicator light, the power indicator light forms an electrical connection with the power control device enable displaying user mode; and
a power supply jack, the power supply jack is separately forms an electrical circuit with the power control device and the power indicator light to supply electricity.

6. The electronic candle structure according to claim 1, which further comprises a power device enabling lithium batteries to be disposed therein to supply electric energy to the power control device and the power indicator light.

7. The electronic candle structure according to claim 1, wherein the aromatic essence candle column and the supporting device assume a transparent state and a semitransparent state.
